(19) United States
(12) Patent Application Publication
(10) Pub. No.: US 2010/0291913 A1
(43) Pub. Date: Nov. 18, 2010

(54) REMOTE CONTROL METHOD BETWEEN MOBILE PHONES

(75) Inventor: Li-Qun Xu, Taipei (TW)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/780,210

(22) Filed: May 14, 2010

(30) Foreign Application Priority Data
May 14, 2009 (TW) 98115996

(51) Int. Cl. H04W 24/00

(52) U.S. Cl. 455/419

(57) ABSTRACT

A remote control method between mobile phones is provided for making a connection between a first mobile phone and a second mobile phone through a telephone exchange apparatus, so that the mobile phones can manipulate each other without a distance restriction and execute multiple commands. The first mobile phone sends a representative code identifying the second mobile phone to the telephone exchange apparatus, the telephone exchange apparatus examines the representative code to obtain information of the second mobile phone, and sends a message of connection to the second mobile phone, for asking to connect the second mobile phone with the first mobile phone. If the second mobile phone permits connection with the first mobile phone, the telephone exchange apparatus assigns a virtual IP address for connecting to the second mobile phone, and the first mobile phone uses the virtual IP address to connect to the second mobile phone.

### CROSS-REFERENCE TO RELATED APPLICATION

This application claims the priority benefit of Taiwan application serial no. 98115996, filed on May 14, 2009. The entirety of the above-mentioned patent application is hereby incorporated by reference herein and made a part of specification.

### BACKGROUND OF THE INVENTION

1. Field of the Invention

The present invention relates to a remote control method between mobile phones. More particularly, the present invention relates to a remote control method between mobile phones through a telephone exchange apparatus.

2. Description of Related Art

Since people increasingly rely on mobile phones, the mobile phones are quickly developed. The mobile phone is not only used for making a phone call, sending messages, etc., to support diverse needs, it can also serve as a commercial secretary, and a user can record important matters and store various data in the mobile phone. As functions of the mobile phone become powerful, operations of the mobile phone also become more complicated. Some users probably do not know how to correctly operate the mobile phone, or inadvertently change a phone setting of the mobile phone and cannot restore it. Therefore, a remote control method is developed, by which the telecommunication company can send a command to the mobile phone to restore the original phone setting for the user.

However, the conventional method can be only used for a single command processing and a one-way control, by which a nearby or subject mobile phone sends a command to another mobile phone which may be remote or at a distance from the subject mobile phone, and the remote mobile phone receives and executes the command. However, according to such method, the command can only be executed by the remote mobile phone, and the nearby mobile phone cannot really control the remote mobile phone.

### SUMMARY OF THE INVENTION

Accordingly, the present invention is directed to a remote control method between mobile phones, by which the mobile phones are free to manipulate each other without a distance restriction and can execute a plurality of commands. In which, the distance restriction means, due to the long distance between a nearby mobile phone and a remote mobile phone, the mobile phones are difficult to control each other.

To achieve the aforementioned advantages, the present invention provides a remote control method between mobile phones, which includes following steps. First, a first mobile phone sends a representative code identifying the second mobile phone to a telephone exchange apparatus. Next, the telephone exchange apparatus examines the representative code to obtain information of the second mobile phone. Then, the telephone exchange apparatus sends a message of connection to the second mobile phone, for asking to connect the second mobile phone with the first mobile phone. If the second mobile phone permits connection with the first mobile phone, the telephone exchange apparatus assigns a virtual Internet Protocol (IP) address for connecting to the second mobile phone, and then the first mobile phone uses the virtual IP address to connect to the second mobile phone.

In an embodiment of the present invention, after the first mobile phone connects to the second mobile phone through the connection between the first mobile phone and the second mobile phone, a command is input externally by a user to the first mobile phone is to be executed by the second mobile phone.

According to the above descriptions, when a user who may be remote or at a distance from a nearby or subject user wants to change a phone setting of the second mobile phone, the remote user can inform the nearby user of such demand, and the nearby user can use the first mobile phone to connect the second mobile phone and input the command. Alternatively, when the information of the second mobile phone is required to be sent to the first mobile phone, though the information is excessive or is inconvenient for delivery, according to the present invention, the first mobile phone can directly read the information of the second mobile phone to search desired data, which is rather simple and efficient.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a remote control method between mobile phones according to an embodiment of the present invention.

FIG. 2 is a schematic diagram illustrating a remote control system between mobile phones according to an embodiment of the present invention.

### DESCRIPTION OF THE EMBODIMENTS

The present invention provides a remote control method between the mobile phones, by which a nearby mobile phone can be directly connected to a remote mobile phone, and after the nearby mobile phone logs in the remote mobile phone, commands can be input through the nearby mobile phone, and the remote mobile phone can execute the commands, so as to control the remote mobile phone. According to the present invention, the nearby mobile phone can control the remote mobile phone without a distance restriction, and can send more than one command, so as to effectively mitigate a shortage of the conventional remote control method.

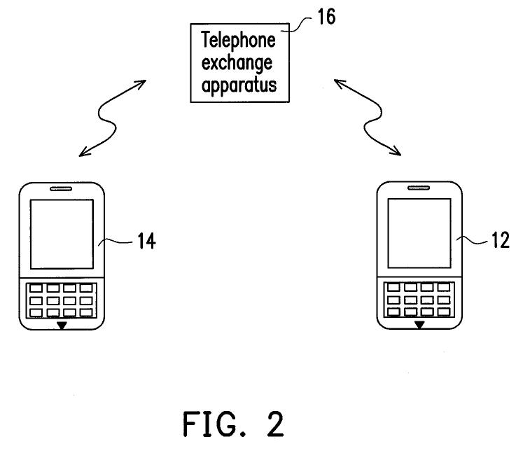

Referring to FIG. 2, FIG. 2 is a schematic diagram illustrating a remote control system between mobile phones according to an embodiment of the present invention. As shown in FIG. 2, the remote control system comprises a first mobile phone 12, a second mobile phone 14 and a telephone exchange apparatus 16. The first mobile phone 12 and the second mobile phone 14 can all be connected to Internet, and can be connected to the telephone exchange apparatus 16. In one embodiment, the telephone exchange apparatus 16 may be a telephone switch apparatus.

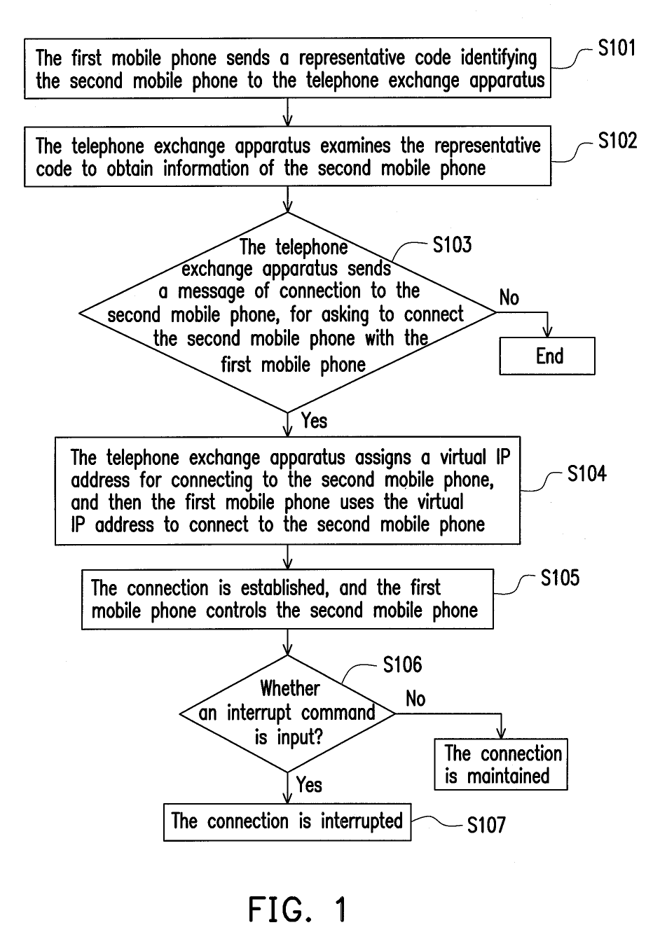

Referring to FIG. 1, FIG. 1 is a flowchart illustrating a process that the first mobile phone 12 controls the second mobile phone 14 in case that a connection is established between the first mobile phone 12 and the telephone exchange apparatus 16, and a method of establishing the connection is as follows.

The first mobile phone 12 sends a representative code identifying the second mobile phone 14 to the telephone exchange apparatus 16, wherein the representative code further includes a phone number of the second mobile phone 14 (S101).

The telephone exchange apparatus 16 examines the representative code to obtain information of the second mobile phone 14 (S102).

The telephone exchange apparatus 16 sends a message of connection to the second mobile phone 14, for asking to connect the second mobile phone 14 with the first mobile phone 12. If the second mobile phone 14 permits connection with the first mobile phone 12, a next step is executed, otherwise, the method illustrated in this embodiment is ended (S103).

The telephone exchange apparatus 16 assigns a virtual Internet Protocol (IP) address (which is generated according to the representative code, and is referred to as virtual IP address hereinafter) for connecting to the second mobile phone 14, and then the first mobile phone 12 uses the virtual IP address to connect to the second mobile phone 14 (S104). For example, the first mobile phone 12 may use the virtual IP address to access the second mobile phone 14, or to log in to the second mobile phone 14.

After the first mobile phone 12 connects to the second mobile phone 14, a display screen of the first mobile phone 12 displays an operation interface of the second mobile phone 14. When a user inputs a command through keys or an external input device of the first mobile phone 12, the command is related to the second mobile phone 14, that is, the command is executed by the second mobile phone 14. Therefore, the user can control the second mobile phone 14 remotely (S105).

Then, it is determined whether or not an interrupt command is input, if yes, a next step is executed, and if not, the connection is maintained (S106).

When the user is about to input the interrupt command to the first mobile phone 12 or the second mobile phone 14, after the interrupt command is input, the first mobile phone 12 and the second mobile phone 14 respectively log out the virtual IP address. Then, the second mobile phone 14 resumes the control thereof, and the first mobile phone 12 also resumes the operation interface thereof (S107).

The representative code mentioned in the step S101 is customized by a telecommunication company, and the representative code includes the phone number of the second mobile phone 14. The representative code is, for example “#*#1234567890**#”, wherein “#*#” is used as start symbols of the representative code, the following string of “1234567890” represents the phone number of the mobile phone to be connected, i.e. the phone number of the second mobile phone 14, and “**#” is used as end symbols of the representative code. The start symbols “#*#” and the end symbols “**#” mentioned above are only examples, and the start symbols and the end symbols of the representative code are not limited thereto.

As described in the step S102, the telephone exchange apparatus 16 examines the representative code, and when the telephone exchange apparatus 16 reads “#*#”, it represents the input string is the representative code for remote control. Then, the telephone exchange apparatus 16 reads the following phone number. In this way, the telephone exchange apparatus 16 may obtain the information of the second mobile phone 14 through the phone number, and may establish the connection with the second mobile phone 14.

As described in the step S103, if the second mobile phone 14 refuses to connect to the first mobile phone 12, the second mobile phone 14 may directly interrupt the connection with the telephone exchange apparatus 16, and the first mobile phone 12 can directly resume its own operation interface. Alternatively, when the second mobile phone 14 refuses the connection, the second mobile phone 14 may further send a response message to the first mobile phone 12 through the telephone exchange apparatus 16, for notifying the first mobile phone 12 that the second mobile phone 14 refuses to connect with the first mobile phone 12.

As described in the step S104, when the second mobile phone 14 permits connection with the first mobile phone 12, the telephone exchange apparatus 16 assigns the virtual IP address for connecting to the second mobile phone 14, and the second mobile phone 14 connects to a device of the virtual IP address. When the first mobile phone 12 connects to the device of the virtual IP address, it can connect to the second mobile phone 14 to read the information of the second mobile phone 14, and the first mobile phone 12 can send commands to control the second mobile phone 14 directly.

As described in the step S105, when the first mobile phone 12 assumes the operation interface of the second mobile phone 14, a command inputted to the first mobile phone 12 is related to the second mobile phone 14, therefore the command is executed by the second mobile phone 14. After connecting to the second mobile phone 14, the user of the first mobile phone 12 can read the information of the second mobile phone 14. Alternatively, the user can send a command to modify the phone setting of the second mobile phone 14. In this way, if the user inadvertently changes the phone setting of the second mobile phone 14, and does not know how to restore it, the method of the present invention can be used to request a remote user to modify the phone setting, which can be a great advantage for elder users or people who does not know how to manipulate the mobile phone.

As described in the step S106, when the interrupt command is input to the first mobile phone 12 or the second mobile phone 14, the remote control connection between the first mobile phone 12 and the second mobile phone 14 is interrupted. If the interrupt command is not input to the first mobile phone 12 or the second mobile phone 14, the remote control connection is continually maintained. The user can input the interrupt command to the first mobile phone 12, and the interrupt command is used for interrupting the connection between the first mobile phone 12 and the second mobile phone 14. After the connection is interrupted, the first mobile phone 12 resumes the operation interface thereof, and the second mobile phone 14 resumes the operation interface thereof. Moreover, the user of the second mobile phone 14 can decide to interrupt the connection. The user can input the interrupt command to the second mobile phone 14 for interrupting the connection between the first mobile phone 12 and the second mobile phone 14. After the connection is interrupted, the first mobile phone 12 resumes the operation interface thereof, and the second mobile phone 14 resumes the operation interface thereof.

According to the above descriptions, the telephone exchange apparatus is used to provide the virtual IP address, so that the remote control of the mobile phones can be truly implemented without a distance restriction. Moreover, as long as the connection of the mobile phones is established, commands can be continually executed. Therefore, compared to the conventional technique that the control end can only send one command to the controlled end, and the controlled end executes the single command for completion, the present invention can achieve more effective data sharing between the mobile phones, which can improve a user's experience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A remote control method between mobile phones, which is related to making a connection between a first mobile phone and a second mobile phone through a telephone exchange apparatus, the remote control method comprising:
the first mobile phone sending a representative code identifying the second mobile phone to the telephone exchange apparatus;
the telephone exchange apparatus examining the representative code to obtain information of the second mobile phone;
the telephone exchange apparatus sending a message of connection to the second mobile phone, for asking to connect the second mobile phone with the first mobile phone; and
if the second mobile phone permits connection with the first mobile phone, the telephone exchange apparatus assigning a virtual Internet Protocol (IP) address for connecting to the second mobile phone, and then the first mobile phone using the virtual IP address to connect to the second mobile phone.

2. The remote control method as claimed in claim 1, wherein after the step of examining the representative code, the method further comprises:
the telephone exchange apparatus generating the virtual IP address according to the representative code;
the second mobile phone connecting to a device of the virtual IP address; and
the first mobile phone connecting to the device of the virtual IP address.

3. The remote control method as claimed in claim 1, wherein after the connection between the first mobile phone and the second mobile phone is established, the first mobile phone assumes an operation interface of the second mobile phone.

4. The remote control method as claimed in claim 1, wherein after the connection between the first mobile phone and the second mobile phone is established, the second mobile phone is controlled by the first mobile phone.

5. The remote control method as claimed in claim 1, wherein the representative code is defined by a user, and the representative code further comprises a phone number of the second mobile phone, which the telephone exchange apparatus uses to connect to the second mobile phone.

6. The remote control method as claimed in claim 1, wherein if the second mobile phone refuses to connect with the first mobile phone, the telephone exchange apparatus sends a response message to the first mobile phone to notify that the second mobile phone refuses to connect with the first mobile phone.

7. The remote control method as claimed in claim 1, wherein after the first mobile phone connects to the second mobile phone, a command is input externally by a user to the first mobile phone to be executed by the second mobile phone.

8. The remote control method as claimed in claim 3, wherein an interrupt command is input to the first mobile phone to interrupt the connection between the first mobile phone and the second mobile phone.

9. The remote control method as claimed in claim 8, wherein when the connection is interrupted, the first mobile phone resumes an operation interface of the first mobile phone, and the second mobile phone resumes the operation interface of the second mobile phone.

10. The remote control method as claimed in claim 3, wherein an interrupt command is input to the second mobile phone to interrupt the connection between the first mobile phone and the second mobile phone.

11. The remote control method as claimed in claim 10, wherein when the connection is interrupted, the first mobile phone resumes an operation interface of the first mobile phone, and the second mobile phone resumes the operation interface of the second mobile phone.

12. A remote control system between mobile phones, comprising:
a first mobile phone;
a second mobile phone; and
a telephone exchange apparatus,
wherein the first mobile phone is configured to send a representative code identifying the second mobile phone to the telephone exchange apparatus;
the telephone exchange apparatus is configured to examine the representative code, and then send a message of connection to the second mobile phone for asking to connect the second mobile phone with the first mobile phone; and
if the second mobile phone permits connection with the first mobile phone, the telephone exchange apparatus is configured to assign a virtual IP address for connecting to the second mobile phone, and then the first mobile phone uses the virtual IP address to connect to the second mobile phone.

13. The remote control system between mobile phones as claimed in claim 12, wherein the representative code comprises a phone number of the second mobile phone.

14. The remote control system between mobile phones as claimed in claim 12, wherein after the connection between the first mobile phone and the second mobile phone is established, a command is input externally by a user to the first mobile phone to be executed by the second mobile phone.

15. The remote control system between mobile phones as claimed in claim 12, wherein after the connection between the first mobile phone and the second mobile phone is established, the first mobile phone assumes an operation interface of the second mobile phone.

16. The remote control system between mobile phones as claimed in claim 15, wherein an interrupt command is input to the first mobile phone or the second mobile phone to interrupt the connection between the first mobile phone and the second mobile phone.

17. The remote control system between mobile phones as claimed in claim 16, wherein after the connection is interrupted, the first mobile phone resumes an operation interface of the first mobile phone, and the second mobile phone resumes the operation interface of the second mobile phone.

18. The remote control system between mobile phones as claimed in claim 12, wherein if the second mobile phone refuses to connect with the first mobile phone, the telephone exchange apparatus sends a response message to the first mobile phone to notify that the second mobile phone refuses to connect with the first mobile phone.
